(19) United States
(12) Patent Application Publication
(10) Pub. No.: US 2009/0006937 A1
(43) Pub. Date: Jan. 1, 2009

(54) OBJECT TRACKING AND CONTENT MONETIZATION

(76) Inventors: Sean KNAPP, Menlo Park, CA (US); Bismarck Lepe, Los Altos, CA (US); Belsasar Lepe, Los Altos, CA (US)

Correspondence Address: GLENN PATENT GROUP, 3475 EDISON WAY, SUITE L, MENLO PARK, CA, 94025, US

(21) Appl. No.: 12/147,307

(22) Filed: Jun. 26, 2008

Related U.S. Application Data
(60) Provisional application No. 60/946,225, filed on Jun. 26, 2007.

(51) Int. Cl. G06F 17/00; G06Q 10/00

(52) U.S. Cl. 715/205; 705/10

(57) ABSTRACT

A system associates objects in a video with metadata; wherein the system contains an unlocking module for unlocking the video by breaking up objects in the video, tracking the objects through the frames, and associating the objects with keywords and metadata. Users including consumers, advertisers, and publishers suggest objects in the video for a tagging module to link to advertisements. A feedback module tracks a user's activities and displays a user interface that includes icons to objects that the tracking module determines would be of interest to the user.

### CROSS REFERENCE TO RELATED APPLICATIONS

This patent application claims the benefit of U.S. provisional patent application Ser. No. 60/946,225, Object Tracking and Content Monetization, filed 26 Jun. 2007, the entirety of which is hereby incorporated by this reference thereto.

### BACKGROUND OF THE INVENTION

1. Technical Field

This invention relates generally to the field of advertising formats. More specifically, this invention relates to video containing objects that are associated with metadata.

2. Description of the Related Art

The Internet is an ideal medium for placing advertisements. The format for online news can be very similar to that of the traditional method of renting advertising space in a newspaper. The advertisements frequently appear in a column on one side of the page. Because these advertisements are easily ignored by users, advertisements can also appear overlaid on text that the user reads. Users find these overlays to be extremely annoying. As a result, not only does the user ignore the advertisement, he may even become angry at the host for subjecting him to the advertisement. Another problem with this approach is that the user is unlikely to be interested in the product because the advertisement is generic. The click-through rate for a randomly generated link, i.e., the likelihood that a user will click on a link, is only 2-3%. Thus, the advertisement has minimal value.

Methods for calculating the value of advertising space continually evolve. In addition to obtaining revenue for displaying advertisements, companies displaying advertisements profit when users click on advertising links. The more clicks, the more revenue for the advertiser. Thus, companies continually change their advertising model in an attempt to entice users into clicking on links. Microsoft®, for example, pays users to click on links. Users sign up for an account and use Live Search. Any purchase made using Live Search entitles the user to a rebate. This system also benefits Microsoft® by providing a way to track users' Internet activities, which is useful for developing a personalized system.

A personalized system increases the likelihood that users are interested in advertisements displayed on a search engine page. Google® provides personalized advertisements for users by matching the keywords used in a search engine with advertisements. Google® sells the keywords to advertisers. This method has garnered a great deal of attention, including several trademark infringement cases for selling trademarked keywords. See, for example, Gov't Employees Ins. Co. v. Google, Inc. (E.D. VA 2005).

Another factor in displaying advertisements that companies consider concerns how to rank the order of advertisements. Some companies, such as Overture Services, which is now owned by Yahoo®, gave priority to advertisers who were willing to pay the most money per click. This system depends, however, on frequent clicks. If an advertiser pays $1 per click, but the link is only clicked once in a day, the company displaying the advertisement generates half as much revenue as a company that displaying a link to an advertiser that pays $0.50 per click and is receiving four clicks in a day. Google®, on the other hand, determines ranking of advertisements according to both the click price and the frequency of clicks to obtain the greatest amount of revenue.

In addition to generating an advertisement based on keywords that a user inputs into a search engine, advertisers pay varying amounts of money according to the user's personal information. For example, Yahoo® considers demographic information that their users provide, in addition to the websites the user visits and the user's search history. MSN® takes into account age, sex, and location. Google® displays advertisements in its email system Gmail® according to keywords taken from users' emails.

Advertising is also incorporated into media. One method, called preroll ads, plays advertisements before the user can view the selected media. Other forms of advertising include product placements and overlays. One example of an overlay is a banner that appears at the bottom of the frame. Users are typically annoyed by overlays that randomly pop-up over the video, especially when they are unrelated to the subject of the video. Even if the videos are personalized to the user, only a limited number of overlays can appear on the screen, and they can only be personalized to one user because only one user logs into the website. Thus, if two people are watching the same video, the advertisement can only be targeted to one of them.

It would be advantageous to provide an advertising format that is capable of displaying a large number of products that can be personalized for multiple viewers.

### SUMMARY OF THE INVENTION

In one embodiment of the invention, the system creates user-initiated revenue-maximizing advertisement opportunities. Advertisements are associated with relevant objects within a video to increase the revenue opportunities from 8-10 advertisement spots to hundreds for a typical 30 minute piece of video content. The system contains a module that breaks the video into segments, associates segments with objects within the frames, and links objects to keywords and metadata. Users can suggest additional items in the video that can be linked to metadata. A module tracks the user's activities and continually modifies a user interface based on those activities.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram that illustrates a system for linking objects in a video with metadata according to one embodiment of the invention;

FIG. 2 is a screen shot that illustrates the frame of a movie with objects within the frame that can be linked to metadata according to one embodiment of the invention;

FIG. 3 is a screen shot that illustrates the frame of a movie with a banner advertisement according to another embodiment of the invention;

FIG. 4 is a figure that illustrates different kinds of metadata that are associated with the objects depicted in FIG. 1 according to one embodiment of the invention;

FIG. 5 is a screen shot that illustrates the frame of a movie with objects within the frame that can be linked to metadata according to one embodiment of the invention;

FIG. 6 is a screen shot that illustrates the frame of a movie in play mode according to one embodiment of the invention;

FIG. 7 is a screen shot that illustrates the frame of the movie depicted in FIG. 6 in user interaction mode according to one embodiment of the invention;

FIG. 8 is a screen shot that illustrates the frame of a movie in user interaction mode for multiple objects associated with metadata according to one embodiment of the invention;

FIG. 9 is a block diagram that illustrates a system for linking objects in a video with metadata according to one embodiment of the invention;

FIG. 10 is a block diagram that illustrates one embodiment in which the system for linking objects in videos with metadata is implemented; and

FIG. 11 is a flowchart that illustrates the steps of a system for linking objects in a video with metadata according to one embodiment of the invention.

### DETAILED DESCRIPTION OF THE INVENTION

In one embodiment, the invention comprises a method and/or an apparatus are configured for advertising so as to provide a video containing objects that are tagged and linked to metadata. One aspect of this invention is the unlocking of video. Once the video is unlocked, a user can watch the video and click on objects in the video to learn more information about the products. The information can be anything including, for example, links to websites where the item can be purchased, an article describing the history of the object, or a community discussion of the product.

This invention increases advertising opportunities because the ability to place advertisements is solely limited by the number of objects in the frame. In addition, a user's clicks are more valuable because users are more likely to click on objects in which they are interested. Furthermore, because the user makes the decision to click on an object, instead of being bombarded by advertisements overlaid onto the video screen, this system benefits the user.

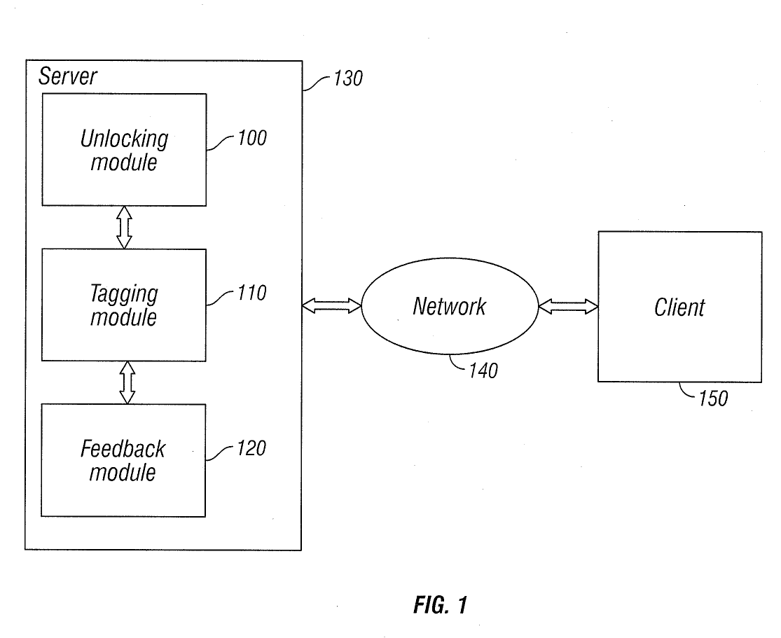

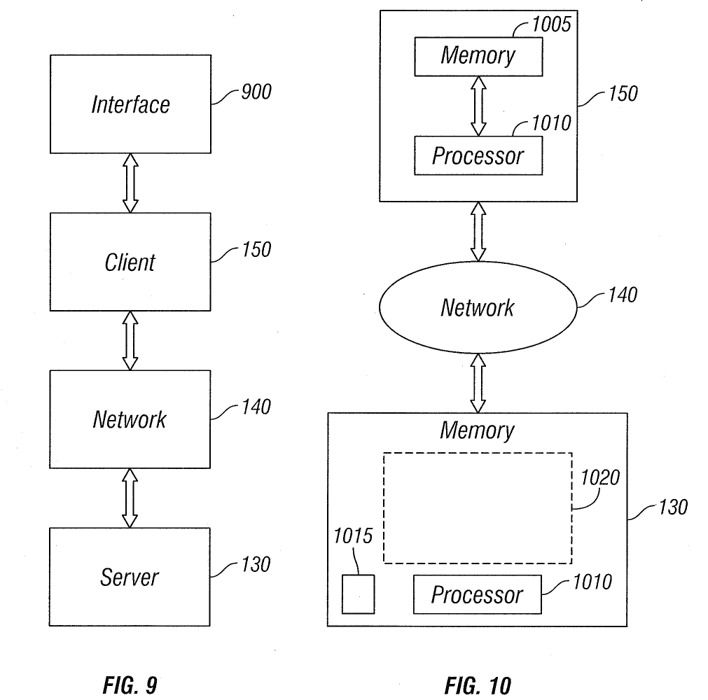

FIG. 1 is a block diagram that illustrates one embodiment of the system for linking objects in videos with metadata where the system can comprise three modules. An unlocking module 100 pairs keywords with objects in the video and tracks these objects from frame to frame. A tagging module 110 allows users to tag objects in the video. A feedback module 120 creates a user interaction feedback loop by tracking a user's clicks and the user's personalized profile, which can include the user's search terms and Internet history, resulting in a personalized video. These modules can be contained in a server 130. The resulting data is transmitted across a network 140 to a client 150. Different embodiments of the server 130, network 140, and client 150 interactions are described below in more detail with regard to FIGS. 9, 10, and 11.

### Unlocking

During the unlocking stage, an unlocking module 130 breaks up a video into many elements and creates objects that are hot, i.e., clickable. There are two triggers for the module to break up the video. First, a user clicks to outline an object of interest. Second, the unlocking module 100 automatically detects an object of interest. Once selected, the unlocking module 100 tracks the object both forwards and backwards in time within the video.

Once the unlocking module 100 breaks up the elements, a person may make any desired corrections. During this process, objects are associated with a set of keywords and metadata. Metadata comprises all types of data. For example, metadata can be links to websites, video or audio clips, a blog, etc. Advertisers can associate advertisements with individual objects within the video by selecting keywords that describe the object linked to the advertisement.

When a user interacts with an object by placing the mouse on top of the object and clicking the object, or by some other mechanism, a window containing metadata is displayed. Because multiple users will click on different objects, these users can watch the same video and each can obtain a different experience. Thus, the advertisements are automatically relevant to a wide variety of viewers.

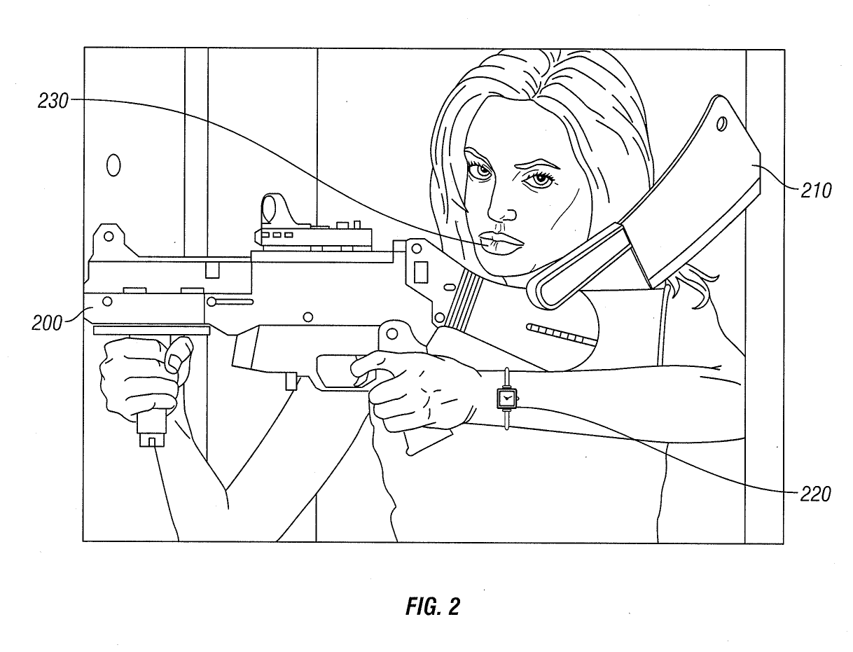

For example, FIG. 2 is a screen shot that illustrates a frame of a movie such as “Mr. and Mrs. Smith,” according to one embodiment of the invention. An actress who could be Angelina Jolie is aiming a machine gun 200 at the moment when someone off screen tries to kill her with a butcher knife 210. Different users are interested in different objects in this picture and can therefore obtain a different interactive experience from clicking on objects of interest. A male user, for example, may wish to learn more about the machine gun 200 held by the actress in the screen shot. A female user, on the other hand, may want to purchase the gold watch 220 that the actress is wearing or even find out about plastic surgeons in the user's area who specialize in using collagen injections to make the user's lips look like the actress's plump lips 230. A chef may be interested in the butcher knife 210. As a result of this format, the number of products that can be linked to objects in the movie is limitless.

If an advertiser wants to place an advertisement for the gold watch 220 worn by the actress in FIG. 2 whenever it appears in the video, the advertiser selects keywords for that watch (e.g., Gucci® gold-plated watch) or broader terms (e.g., Gucci® watch, gold-plated watch, or watch). The system associates the keywords with objects and displays the advertising in meta windows when the user interacts with the object. These meta windows can take many forms including windows containing sponsored listings, banner advertisements, or interstitials. Interstitials are advertisements that appear in a separate browser. This system is ideal for advertisers because they need only select relevant keywords to link their advertisements rather than select a piece of content and/or placement.

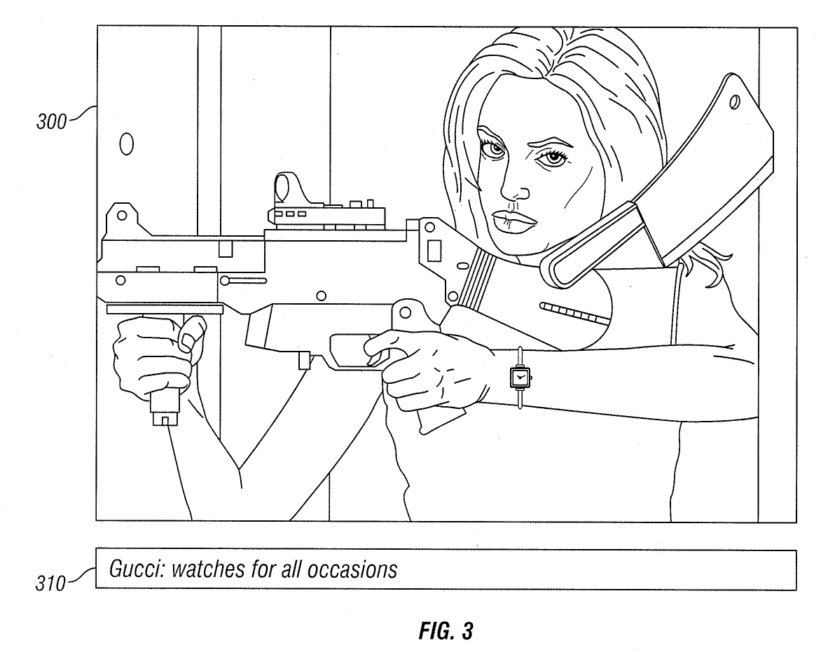

When an advertiser submits keywords for an object, the advertisement can comprise a link that is embedded with the object and that allows the user to click on the object to obtain a website with information. Alternatively, each time the object appears in the video, a banner can appear in another area, such as at the bottom of the screen. FIG. 3 illustrates one embodiment of the invention, where a banner 310 advertising Gucci watches scrolls along the bottom of the screen 300 each time the watch 220 appears onscreen 300.

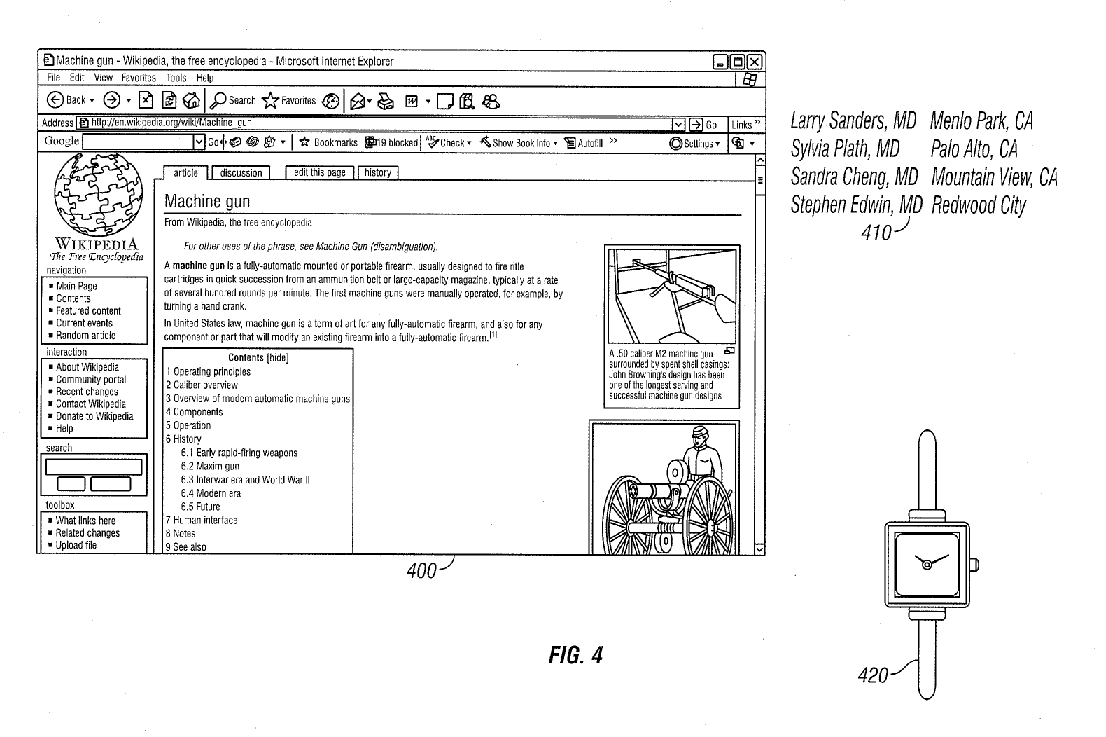

The information linked to the object can be general or specific. For example, FIG. 4 illustrates that if a user clicks on the machine gun, he can obtain a Wikipedia® article on machine guns 400. If a user clicks on the actress's lips, she can obtain a list of plastic surgeons in the Bay Area 410. Lastly, if a user wants to purchase the watch worn by the actress in the movie, the link could be connected to a listing for that particular watch 420.

This video can be displayed, for example, on a computer display. When consumers watch the video and click on the links, windows can appear that contain information about the product and where to purchase the product online, or by referring to a local store or dealer. For example, if a consumer is looking at a screenshot as illustrated in FIG. 2, the user can learn that the butcher knife 210 is available from an online kitchen store, the watch 220 is available from an online jewelry store, and a toy version of the machine gun 200 is available from an online toy store.

In one embodiment of the invention, an advertiser can create and manage keywords using the following steps:

1. The advertiser clicks on a link to create a campaign on an advertising platform.

2. Then, the advertiser selects geographic, language, keyword, or object targeting. The geographic target is set to the location of the advertisers' customers. The language targeting is used to only show advertisements in regions where a particular language is spoken.

3. Next, the advertiser selects targeting criteria including keywords or objects. The keywords comprise those terms that are directly related to a specific object with which the advertiser would like to place an advertisement. To simplify the process for the advertiser, he can also select from a preset list of images that already have metadata associated with the objects.

4. Then, the system can select an appropriate advertisement to serve to the user from, e.g., a creative library. This selection can be made from any advertising type that may include text, image, audio, or video advertisements. The form of the advertisement can be, e.g., a link to a website, banners, or interstitials. These advertisements can reside in the system or be requested from an outside source with metadata provided by the system. The selection criteria and serving priority of the advertisements can depend on a number of factors which may include revenue generation, advertising relevance to a user and object metadata, geographic location of a user, or length of the advertising creative.

5. Lastly, the system sets up pricing and daily budgets.

Once the keywords are set up, the unlocking module 100 places the advertisements and links the objects with metadata. Advertisements are served into the meta window once a user interacts with one of the objects. In the advertisement management system, an impression is reported whenever a meta window appears. A click is reported when someone clicks an advertisement. The cost to the advertiser can be calculated as the total price the advertiser pays after aggregation of the cost across impressions, clicks, and interactions for the specified period of time. For example, the cost can be calculated as a function of the time that a user spends engaging with the meta window (engagement time post click) or the number of clicks made after the meta window appears.

As soon as advertisers have been selected, the video images are processed. Processing can proceed as follows. First, the video is broken up into segments. Once the video has been segmented, specific regions are selected either manually or automatically. These regions can correspond to objects of interest. These regions are tracked in video frames before and after resulting in a temporal representation for the object of interest. The unlocking module 100 adds a data layer that includes both advertisements and content to the video to convert static content into hot/clickable content. A human can review the process to correct for any errors.

### Manual Tagging

Once the unlocking module 100 associates objects with links, the tagging module 110 links objects identified by users. There are three types of users that can make suggestions: consumers, advertisers, and publishers. Consumers are users with the potential to buy products associated with objects in the movie. Consumers may link objects with metadata, including general information about the object, for example from a Wikipedia article. Advertisers are users that purchase keywords from the video maker to associate an object in a video with a product. Advertisers may identify opportunities to link their products to objects in the video. These links are not limited to the specific product. For example, an advertiser may want to link an advertisement for a BMW with a picture of a different type of sports car that is in the video because consumers may be interested in a variety of sports cars. Lastly, publishers are users that display the video on their website. They may act as an intermediary between publishers and the video maker. Publishers may have sponsors that pay them to advertise products. Thus, the publisher will watch the videos to identify ways to link a sponsor's products to objects in the video.

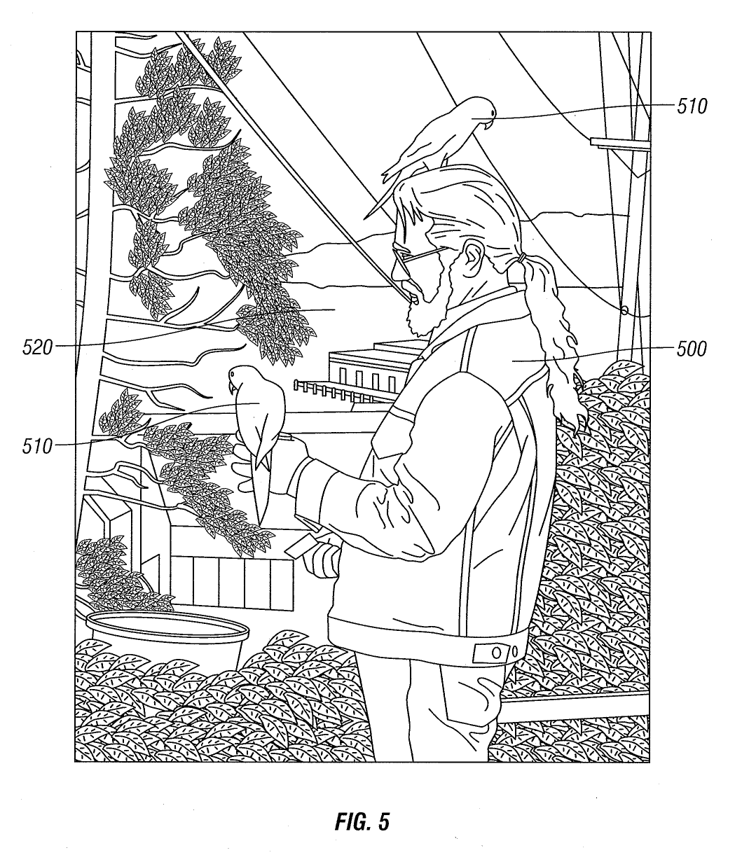

The tagging 110 module can link any objects in a video. For example, FIG. 5 depicts a screen shot illustrating a frame of a movie that could be “The Wild Parrots of Telegraph Hill.” In this frame, the actor 500 holds a cherry-headed conure 510 on his hand and another cherry-headed conure 510 rests on his head. The actor stands on top of Telegraph Hill in San Francisco. In the background, the San Francisco Bay 520 and Angel Island 530 are visible. Thus, an advertiser may suggest linking the view of the Bay 520 or Angel Island 530 to tourism websites. A consumer may suggest linking the Bay 520 view to an online community for submitting digital photographs of the Bay 520 or provide coordinates for a global positioning system (GPS) for the actor's location. If the actor in the movie is Mark Bittner, consumers that are passionate about his efforts to educate the public about non-native birds living in San Francisco could suggest that the actor in this frame be linked to websites containing Bittner's writings, artwork from the movie, etc. Finally, the conures 510 could be linked to a discussion of the San Francisco ban on feeding wild parrots in city parks or a list of bird food supply stores.

Instead of creating a video that links objects to the interests of all consumers, advertisers, and publishers, this video could be linked solely for educational purposes. For example, students can view educational videos with linked objects. For example, if the students were to watch a movie such as the one depicted in FIG. 5, for example, they could learn more about conures 510, San Francisco Bay 520, Angel Island 530, etc., by clicking on objects linked to educational websites. By making the video more interactive, students are more engaged and more likely to enjoy the educational process.

In another embodiment, an advertiser can use highly specific criteria for tagging objects. For example, if a shop owner knows that his restaurant is featured in a movie, he could pay to associate the frames containing his restaurant to a link. When users click on the restaurant in the movie, they could be linked to an advertisement, or even a coupon, for the restaurant.

In one embodiment, the tagging module 110 is an incentive-based module that rewards users for submitting metadata information. For example, if a user provides a certain number of links to objects in a video, the tagging module 110 can reward the user by having the user's link come up first when another user selects the associated object for a predetermined amount of time, e.g., one month.

### Feedback Loop

The feedback module 120 can create a personalized user interface for consumers by tracking the interests of a particular user and by customizing the videos. The feedback module can track each user, for example, through a user's Internet Protocol address or by requiring a user to create a profile where the user could enter demographic or psychographic information. The feedback module 120 can track the videos that the user watches, track the number of clicks made by each user, the number of displays, the time that the user spends on a meta window, or the number of times a user clicks after the meta window is displayed. From these activities, the feedback module 120 can create a personalized experience for the user by determining the user's potential interest.

For example, if a user always clicks on links to jewelry in videos, banners for jewelry are displayed each time jewelry appears in a frame. This way, a user can view targeted advertising that is helpful instead of being annoying. In addition, the profile can contain information such as a user's demographics. As a result, the advertisements can be tailored to those demographics. For example, if the user is a fifteen year old boy, banners for video games can be displayed. By personalizing the experience, a user enjoys the advertisement and is more willing to purchase the item.

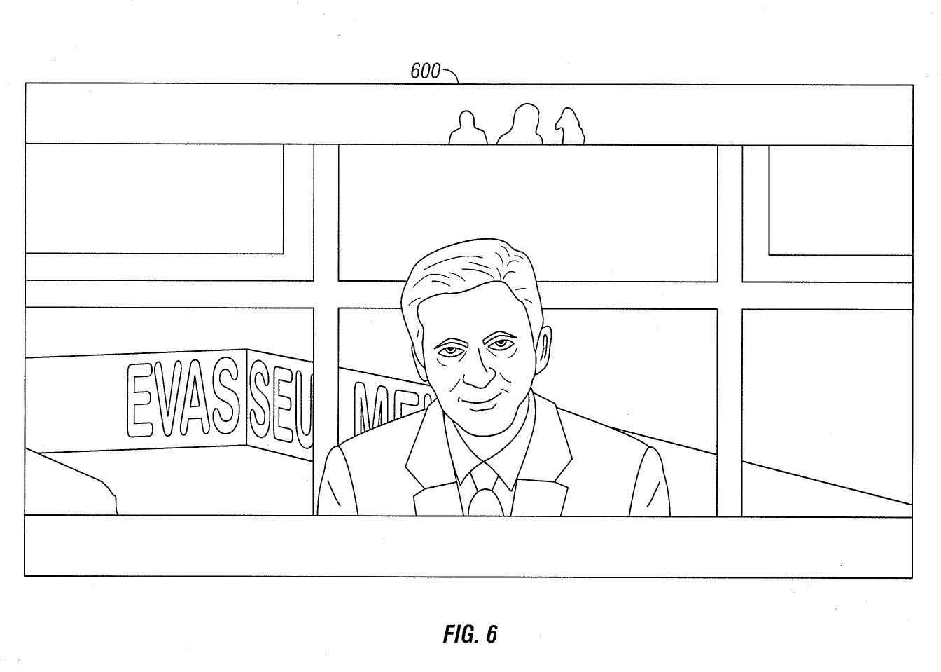

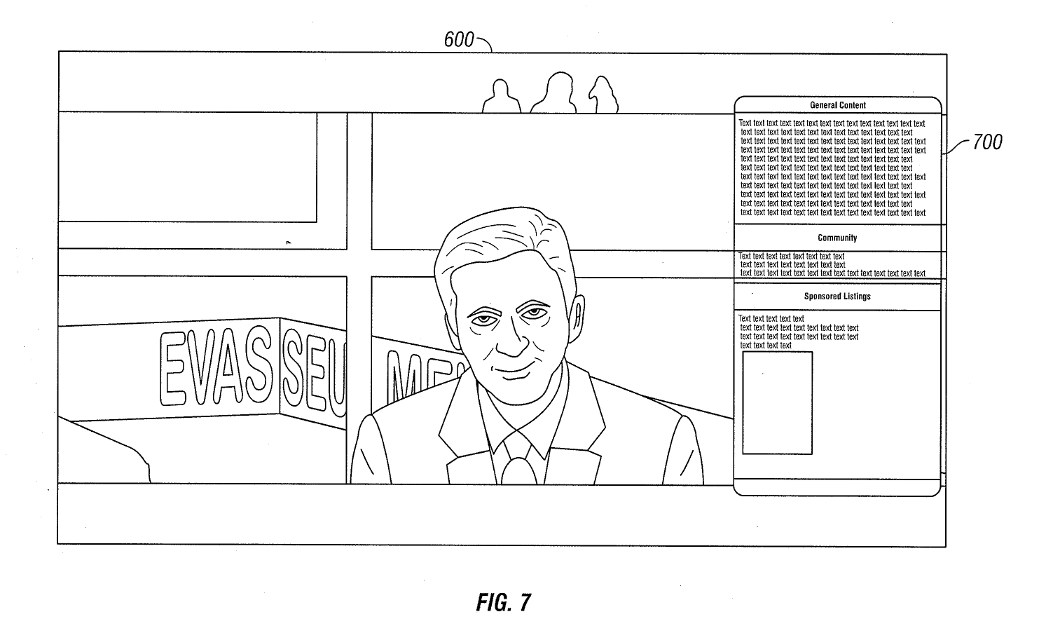

The more information that the feedback module 120 has about a user, the more it can serve a user's needs. In addition to providing banners that may interest the user, the feedback module determines which items are of interest to a user and they are displayed as icons. FIGS. 6 and 7 illustrate this feature.

FIG. 6 is a diagram that illustrates a video in play mode. The user enjoys a high-quality viewing experience without any advertisements. The feedback module 120 determines which objects are more important to the user. These objects are displayed as customized thumbnails 600 on the top of the frame.

FIG. 7 is a diagram that illustrates a video in user interaction mode. If the user clicks on one of the thumbnails 600 or pauses the video, the hot areas become visible. When the user clicks on one of the objects, a meta window 700 opens with a pre-populated content area containing a place where the community can edit the content and an area for targeted advertisements.

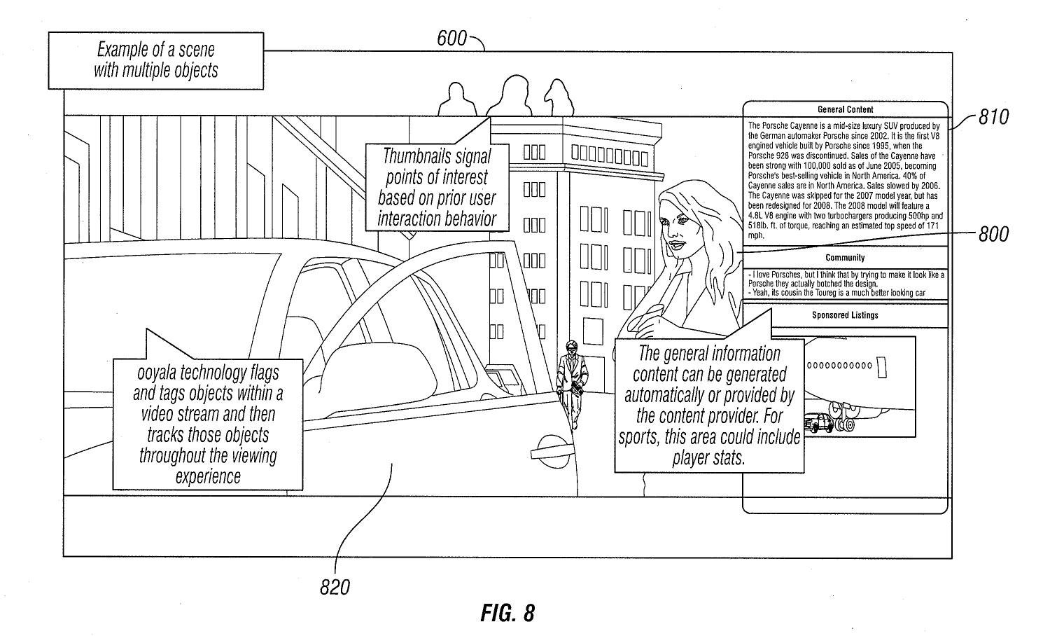

FIG. 8 is a diagram that illustrates a video in user interaction mode where there are multiple objects of interest to a user. The window contains a thumbnail 600 depicting items in the scene that are of interest to the user including a picture of the woman 800 using her cell phone. The woman 800 is surrounded by shading to indicate that the object is hot. Objects are shaded when the user places an arrow over the object or can appear when the video is paused. The user clicks on the car 820 to obtain metadata 810. The metadata 810 depicted here includes general content regarding the Porsche Cayenne, a community where users can blog about the Porsche, and sponsored listings where advertisers can have their advertisements displayed.

FIG. 9 is a block diagram that illustrates a system for displaying videos with objects linked to metadata. The environment includes a user interface 900, a client 150 (e.g., a computing platform configured to act as a client device, such as a computer, a digital media player, a personal digital assistant, a cellular telephone), a network 140 (e.g., a local area network, a home network, the Internet), and a server 130 (e.g., a computing platform configured to act as a server). In one embodiment, the network 140 can be implemented via wireless and/or wired solutions.

In one embodiment, one or more user interface 900 components are made integral with the client 150 (e.g., keypad and video display screen input and output interfaces in the same housing as personal digital assistant electronics). In other embodiments, one or more user interface 900 components (e.g., a keyboard, a display) are physically separate from, and are conventionally coupled to, the client 150. A user uses the interface 900 to access and control content and applications stored in the client 150, server 130, or a remote storage device (not shown) coupled via a network 140.

In accordance with the invention, embodiments illustrating schemes for linking objects in video with metadata as described below are executed by an electronic processor in a client 150, in a server 130, or by processors in a client 150 and in a server 130 acting together. The server 130 is illustrated in FIG. 9 as being a single computing platform, but in other instances are two or more interconnected computing platforms that act in concert.

FIG. 10 is a simplified diagram illustrating an exemplary architecture in which the system for linking objects in videos with metadata is implemented. The exemplary architecture includes a client 150, a server 130 device, and a network 140 connecting the client 150 to the server 130. The client 150 is configured to include a computer-readable medium 1005, such as random access memory or magnetic or optical media, coupled to an electronic processor 1010. The processor 1010 executes program instructions stored in the computer-readable medium 1005. A user operates each client 150 via an interface 900 as described in FIG. 9.

The server 130 device includes a processor 1010 coupled to a computer-readable medium 1020. In one embodiment, the server 130 device is coupled to one or more additional external or internal devices, such as, without limitation, a secondary data storage element, such as a database 1015.

The server 130 includes instructions for a customized application that includes a system for linking objects in videos with metadata. In one embodiment, the client 150 contains, in part, the customized application. Additionally, the client 905 and the server 130 are configured to receive and transmit electronic messages for use with the customized application.

One or more user applications are stored in memories 1005, in memory 1020, or a single user application is stored in part in one memory 1005 and in part in memory 1020.

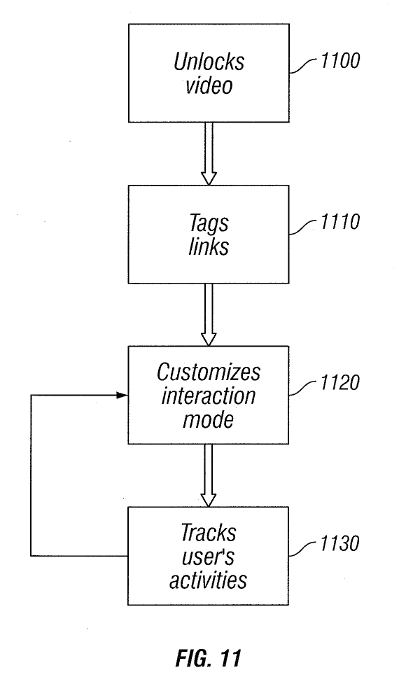

FIG. 11 is a flowchart that illustrates the steps of a system for linking objects in a video with metadata according to one embodiment of the invention. The blocks within the flow diagram can be performed in a different sequence without departing from the spirit of the system. Furthermore, blocks can be deleted, added, or combined without departing from the spirit of the system.

An unlocking module 100 unlocks 1100 the video. The unlocking module 100 automatically associates advertising keywords with objects in the video. A tagging module 110 tags 1110 any user submitted links. A feedback module 120 customizes 1120 an interaction mode display. A feedback loop is created where the feedback module 120 tracks 1130 the user's clicks. The information is then used to further customize 1120 the interaction mode, thereby completing the feedback loop.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer implemented method for associating objects in videos with metadata, comprising the steps of:
storing a video on a computer-readable medium;
unlocking said video, said video comprising a plurality of frames, by creating interactive objects within said frames; and
associating said objects with links to metadata.

2. The method of claim 1, said metadata comprising any of media, blogs, audio clips, video clips, and websites.

3. The method of claim 1, further comprising the steps of:
receiving links to metadata for associations with an object from a user, said user comprising at least a consumer, a publisher, and an advertiser; and
associating said links to metadata from said user with said objects.

4. The method of claim 1, further comprising the step of:
providing content for linking objects to metadata.

5. The method of claim 1, wherein said tracking step further comprising the step of:
tracking each user.

6. The method of claim 5, wherein the step of tracking further comprises recording a user's activities by tracking at least one of:
a number of clicks made by each user;
a number of displays;
an engagement time post click; and
a number of clicks occurring after said engagement time post initial click.

7. The method of claim 6, further comprising:
determining a user's potential interest from at least one of said tracking steps, said user's psychographics, and said user's demographics.

8. The method of claim 7, further comprising:
displaying at least one of banners, interstitials, and other forms of media based on said user's potential interest.

9. The method of claim 6, the step of tracking the user's activities further comprising the step of:
tracking words typed by each user while interacting with said metadata.

10. The method of claim 6, further comprising:
identifying objects a user clicks on in videos;
determining a likelihood that said user will click on an object in each video frame; and
displaying representations of objects to said user that have the highest likelihood of being clicked on by said user.

11. A system stored on a computer-readable medium for associating objects in videos with metadata comprising:
a module configured to store video on a computer-readable medium;
a module configured to unlock said video, said video comprising a plurality of frames by creating interactive objects within said frames; and
a module configured to associate said objects with links to metadata.

12. The system of claim 11, said metadata comprising any of media, blogs, audio clips, video clips, and websites.

13. The system of claim 11, further comprising:
a module for receiving links to metadata for associations with an object from a user, said user comprising at least a consumer, a publisher, and an advertiser; and
a module for associating said links to metadata from said user with said objects.

14. The system of claim 11, further comprising:
a module for providing content for linking objects to metadata.

15. The system of claim 11, further comprising:
a module for tracking each user.

16. The system of claim 15, wherein said tracking module tracks a user's activities by recording at least one of:
a number of clicks made by each user;
a number of displays;
an engagement time post click; and
a number of clicks occurring after said engagement time post initial click.

17. The system of claim 16, wherein said tracking module determines a user's potential interest from at least one of said user's tracked activities, said user's psychographics, and said user's demographics.

18. The system of claim 17, further comprising:
a module for displaying at least one of banners, interstitials, and other forms of media based on said user's potential interest.

19. The system of claim 16, wherein said tracking module tracks words typed by each user while interacting with said metadata.

20. The system of claim 16, further comprising:
a module for identifying objects a user clicks on in videos;
a module for determining a likelihood that said user will click on an object in each video frame; and
a module for displaying icons of objects to said user that have the highest likelihood of being clicked by said user.
